(19) United States
(12) Patent Application Publication
(10) Pub. No.: US 2021/0019780 A1
(43) Pub. Date: Jan. 21, 2021

(54) ADAPTER FOR USE WITH DISPLAY

(71) Applicant: WESTONEXPRESSIONS INC., Kitchener (CA)

(72) Inventors: Douglas LUSTED, Ajax (CA); Ashok PATEL, Waterloo (CA)

(21) Appl. No.: 17/062,027

(22) Filed: Oct. 2, 2020

Related U.S. Application Data
(63) Continuation of application No. 15/847,513, filed on Dec. 19, 2017, now abandoned.
Application No. 15/847,513 is a continuation of application No. 14/763,009, filed on Jul. 23, 2015, now abandoned.
(60) Provisional application No. 61/756,181, filed on Jan. 24, 2013.
(60) Provisional application No. 61/816,298, filed on Apr. 26, 2013.

(51) Int. Cl. G06Q 30/02; H04L 12/64; G09G 3/36; G06K 7/10; G09G 5/00; G09G 5/36; G06F 3/147

(52) U.S. Cl. CPC G06Q 30/0241; H04L 12/6418; G06Q 30/0255; G09G 3/36; G09G 2370/12; G09G 5/00; G09G 5/363; G09G 5/006; G06F 3/147; G06K 7/10366

(57) ABSTRACT

An adapter for use with a display includes an interface for communicating with a server; a processor; and a sensor portion for retrieving impression information wherein the processor retrieves the user content via the interface for display by the display and the sensor portion retrieves impression information associated with the user content being displayed.

### CROSS-REFERENCE TO RELATED APPLICATIONS

This application is a continuation of application Ser. No. 15/847,513, filed Dec. 19, 2017; which is a continuation of application Ser. No. 14/763,009, filed Jul. 23, 2015; which is a 371 application of Serial No. PCT/CA2013/050565, filed Jul. 19, 2013; which claims the benefit of priority from U.S. Provisional application No. 61/756,181, filed Jan. 24, 2013; and U.S. Provisional application No. 61/816,298, filed Apr. 26, 2013. The complete disclosure of each prior application is hereby incorporated by reference.

### FIELD OF THE DISCLOSURE

The disclosure is generally directed at displays and more specifically at an adapter for use with a display.

### BACKGROUND OF THE DISCLOSURE

In the field of marketing, there is a benefit to understanding the effectiveness of the advertising being used and the attraction of users to the advertisement. This is even more relevant when dealing with advertising in public spaces. While many different methods of outdoor advertising are known, correlating the number of individuals who look at this advertising is typically a manual exercise requiring an individual to be on site to count or track the people passing by the advertisement.

Therefore, there is provided a novel method and system for establishing an adapter for use with a display to assist in determining advertising popularity.

### SUMMARY OF THE DISCLOSURE

In one aspect of the disclosure, there is provided an adapter for use with a display for displaying user content comprising an interface for communicating with a server; a processor; and a sensor portion for retrieving impression information; wherein the processor retrieves the user content via the interface for display by the display and the sensor portion retrieves impression information associated with the user content being displayed.

### BRIEF DESCRIPTION OF THE DRAWINGS

Embodiments of the present disclosure will now be described, by way of example only, with reference to the attached Figures.

FIG. 1 is a schematic diagram of a system for collecting information regarding advertising content;

FIG. 2a is a schematic diagram of a first embodiment of a display for use in the system of FIG. 1;

FIG. 2b is a schematic diagram of a second embodiment of a display for use in the system of FIG. 1;

FIG. 3a is a schematic diagram of a first embodiment of an adapter for use with the system of FIG. 1;

FIG. 3b is a schematic diagram of a second embodiment of an adapter for use with the system of FIG. 1;

FIG. 3c is a schematic diagram of a third embodiment of an adapter for use with the system of FIG. 1;

FIG. 4a is a flowchart outlining a first method of adapter operation;

FIG. 4b is a flowchart outlining a second method of adapter operation;

FIG. 5 is a flowchart outlining an initiation procedure for an adapter;

FIG. 6 is a flowchart outlining a further method of adapter operation; and

FIG. 7 is a flowchart outlining yet another method of adapter operation.

### DETAILED DESCRIPTION OF THE DISCLOSURE

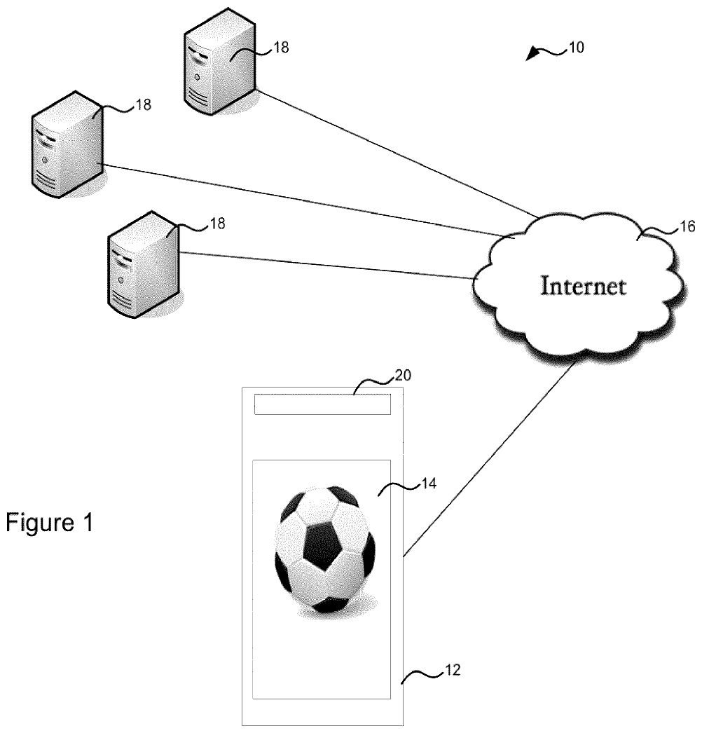

Turning to FIG. 1, a schematic diagram of a system for collecting information regarding user content, such as advertising content is shown. In this system 10, a display 12 including a screen 14 such as a monitor or a large liquid crystal display (LCD) screen, is used for displaying user content such as, but not limited to advertising content. The display 12 is connected via the Internet 16, or an Internet cloud network, to a set of servers 18 which are associated with different organizations, companies or entities (further defined as organizations) and also store advertising content for these organizations. In normal operation, these organizations purchase advertising time or space on the display 12 to show their advertising content.

The display 12 further includes an adapter 20 which is used to assist in collecting information associated with effectiveness the advertising content. The information, which may be seen as impression information, may be transmitted to the organizations, such as by transmitting this information to their associated server 18 so that the impression information may be used by the organization to analyze the effectiveness of the advertising which is being shown on the display 12. In an alternative embodiment, the impression information may be analyzed or processed by the adapter and the results transmitted to the organization. In one embodiment, the adapter 20 may be a near field communication (NFC) adapter while in another embodiment, the adapter 20 may be a proximity sensor adapter.

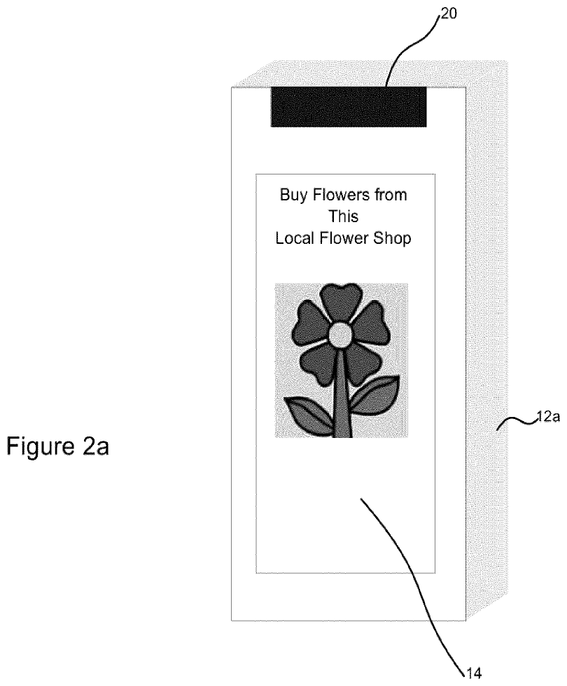

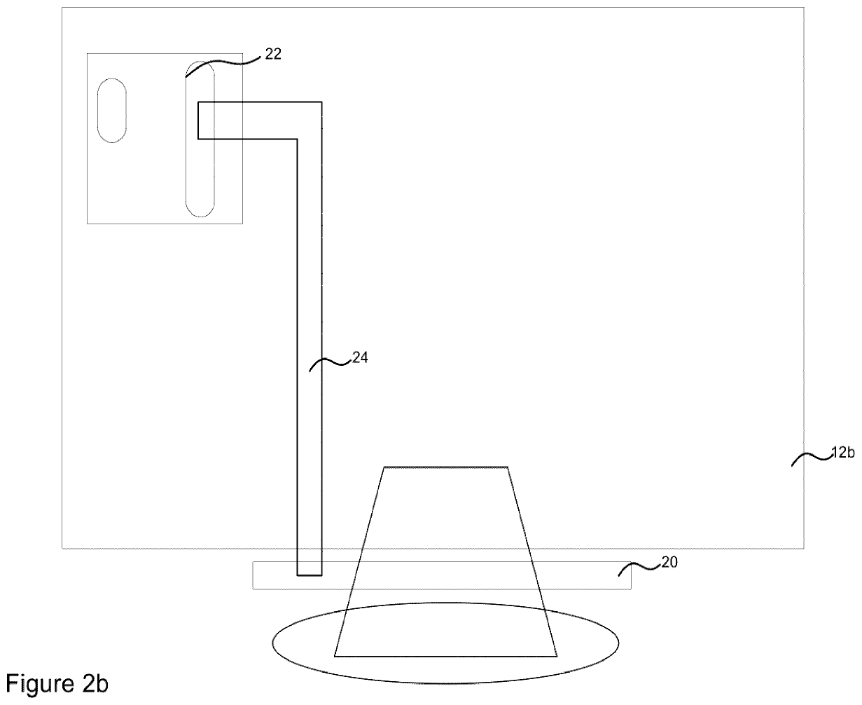

Turning to FIG. 2a, a schematic diagram of a first embodiment of a display is shown. As discussed above, the display 12 (which in the current embodiment is a standalone LCD screen 12a), includes the adapter 20 which may be either the NFC adapter or the proximity sensor adapter or an adapter which includes both functionality that is integrated within the display 12. In one example of operation, the adapter 20 may assist in sensing the presence of individuals proximate the display when advertising content is being displayed. This will be described in more detail below.

Turning to FIG. 2b, a schematic diagram of a second embodiment of a display is shown. In this embodiment, the display 12 is a monitor 12b which has the adapter 20 mounted to a portion of the monitor 12b.

The monitor 12b includes an interface port 22 such as, but not limited to, an HDMI port, a VGI port or DisplayPorts, which is connected to the adapter 20. In one embodiment, the connection between the interface port 22 and the adapter 20 is via a cable 24, however, other methods and apparatus for allowing communication to occur between the monitor 12b and the adapter 20 are contemplated.

In one method of operation, assuming that the adapter 20 is an NFC adapter, the monitor 12b displays the advertising content advertisement or various products which may also serve to notify consumers of the NFC capability of the adapter 20. By waving a mobile communication device or any device having NFC capabilities near the adapter 20 or by tapping the device against the adapter 20, the user may then be provided with an application, coupon, advertisement, or other relevant information associated with what is displayed on the monitor 12b. This further data can then be viewed by the user on their mobile communication device. In the preferred embodiment, the advertising content being shown on the display as well as the information to be outputted from the adapter to mobile communication devices changes on a regular basis according to the organization's needs through the Internet 16.

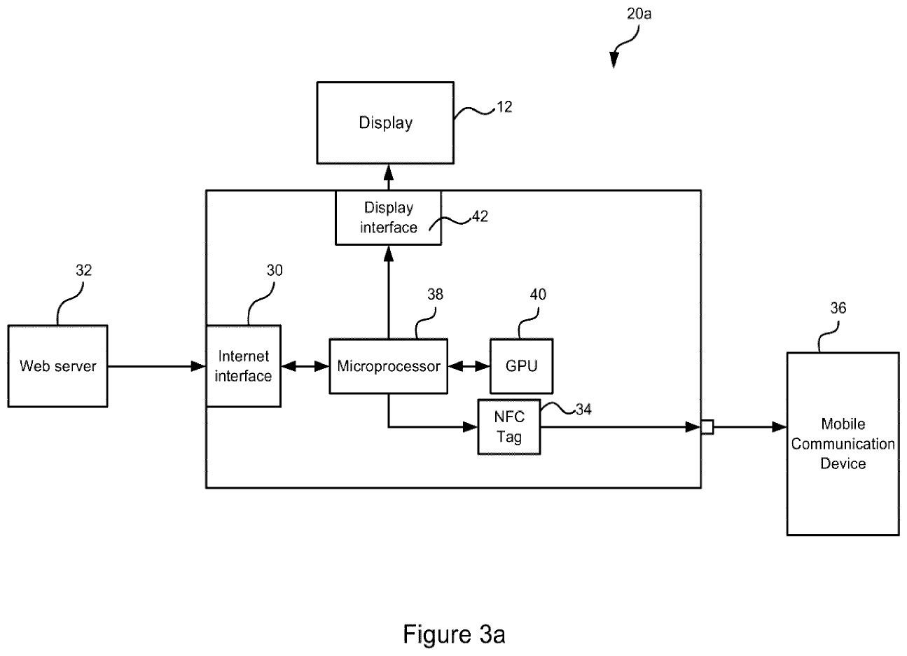

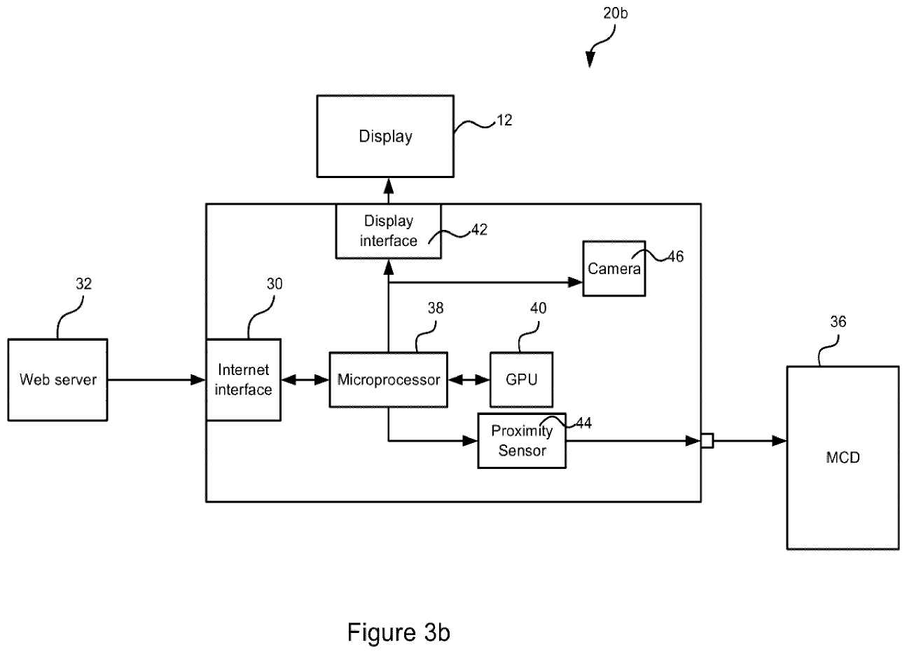

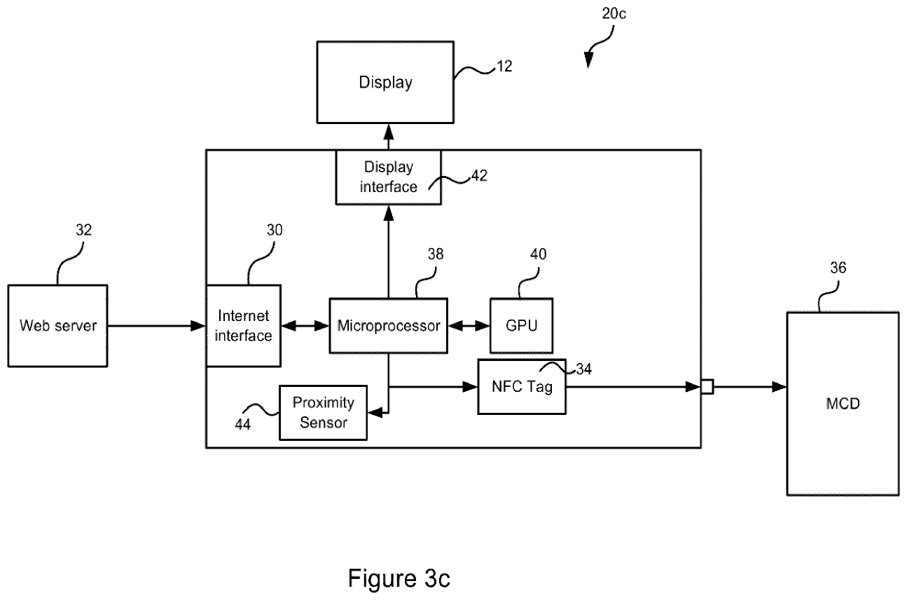

Turning to FIG. 3a, a schematic diagram of a first embodiment of an adapter is shown. In this embodiment, the adapter 20 may be seen as a NFC adapter 20a. The NFC adapter 20a includes an interface 30 which allows the NFC adapter 20a to communicate with servers 32, which may also be servers 18 of FIG. 1, to retrieve user content (such as advertising content and associated data) to be both shown on the display 12 and to be stored in an NFC tag 34. The NFC tag 34 may also be seen as a sensor portion. The NFC tag 34 stores the data which may then be forwarded (via NFC) to a mobile device 36 when a user determines they wish to obtain this data by waving the mobile device 36 near the adapter 20a or by tapping the device 36 on the adapter 20a. The adapter 20a further includes a microprocessor 38 which is in communication with the interface 30, a graphics processing unit 40 such as a graphics card and the NFC tag 34. The graphics processing unit 40 is in communication with the display 12 via a display interface or port 42 in which the cable is plugged or connected. Alternatively, the communication between the adapter 20a and the display 12 may be performed wirelessly. As understood, if the communication between the display 12 and the NFC adapter 20a is wireless, the port 42 may be seen as a communication interface between the adapter 20a and the display.

The NFC tag 34 may also be used to obtain impression information by determining the number of users who request further content or data from the NFC tag 34.

Turning to FIG. 3b, a second embodiment of an adapter for use with a display is shown. The adapter 20 in the current embodiment may be seen as a proximity sensor adapter 20b. The adapter 20b includes interface 30 which allows the adapter 20b to communicate with at least one web server 32 to transmit information which has been collected by the adapter 20b such as via a proximity sensor 44 or sensor portion. In another embodiment, the web server 32 may be part of the Internet cloud network such as shown in FIG. 1.

The proximity sensor 44 detects the presence of individuals proximate the adapter 20b to determine impression information relating to the number of people around the adapter 20b. This impression information may be used to determine the popularity or effectiveness of the advertising content being displayed on the monitor 12b or screen 12a. In another embodiment, the proximity sensor 44 may have apparatus for detecting the presence of mobile communication devices 36 proximate the adapter 20b rather than individuals. In the preferred embodiment, the proximity sensor 44 is used to correlate the popularity or effectiveness of specific advertising content being shown by sensing the number of people proximate the adapter 20b or by just sensing that there are people proximate the adapter 20b.

The adapter may further include the microprocessor 38 which is in communication with the interface 30, a graphics processing unit 40 and the proximity sensor 44. Communication, either wirelessly or wired, between the adapter 20b and the display 12 is via the display interface 42.

In operation with the proximity sensor adapter 20b, the monitor 12b or display screen 12a is showing advertising content in the form of an advertisement for a product or service which has been requested by the organization who has purchased the advertising space on the display 12. This advertisement is generally supplied to the display 12 via one of the servers 18 or 32 associated with the organization providing the advertising content. As the user content is being displayed, the proximity sensor 44 senses the number of individuals which are proximate the display 12 or adapter 20b and transmits this impression information to the processor 38. The impression information may include the number of individuals who are proximate the adapter 20b or the length of time the individuals are proximate the adapter 20b or both. In another embodiment, the adapter 20b may include a camera 46 or the adapter may be connected with a camera to provide visuals of the individuals proximate the adapter 20b. The data from the camera, such as a video or a snapshot, may be used to further identify if individuals proximate the adapter 20b are looking at or facing away from the display 12.

Turning to FIG. 3c, a further embodiment of an adapter is shown. In this embodiment, the adapter 20c includes both a NFC tag 34 and a proximity sensor 44. Although not shown, the adapter 20c may also include a camera. The adapter 20c allows for the combination of functionalities as described above with respect to FIGS. 3a and 3b.

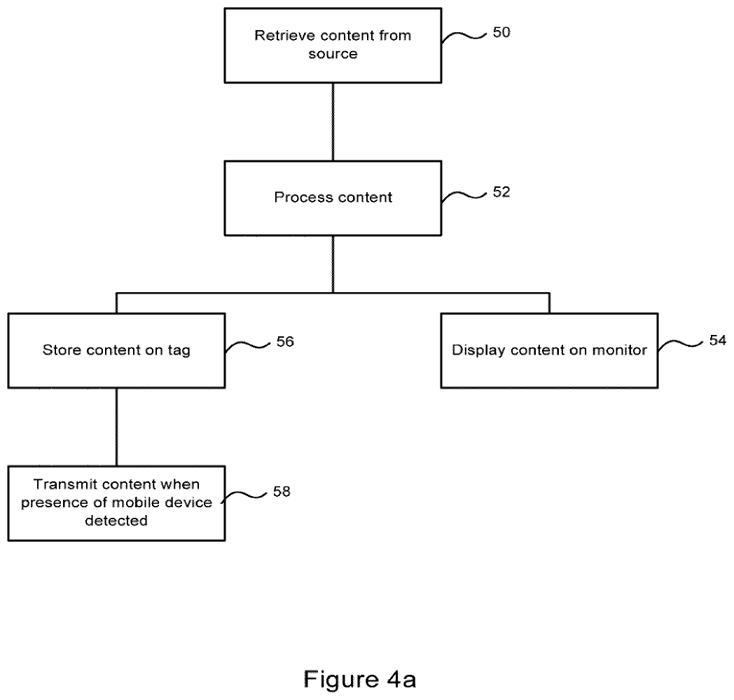

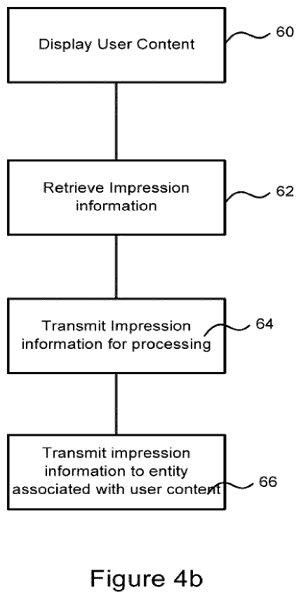

Turning to FIG. 4a, a flowchart outlining a first embodiment of adapter operation is shown. In the current flowchart, it is assumed that the NFC adapter 20a is being used or the combined adapter 20c is being used. In operation, after the information and/or advertising content that is to be displayed on the display 12 and stored in the tag 34 is determined, this desired content is retrieved 50 from a source, such as a web server 18 via the Internet cloud 16 by the adapter 20a or 20c. In one embodiment, the microprocessor 38 retrieves the content via the interface 30. The communication between the interface 30 and the server 18 may be wireless or via a wired connection.

It is understood that the communication between the adapter 20a or 20c and the server 18 may be on a regular basis or may be determined via a schedule. After the connection between the adapter 20a or 20c and the server 18 is completed, the content and data is then downloaded from the server 18 to the adapter 20a or 20c. Once the advertising content is downloaded, or retrieved, the content and data is processed 52 and then transmitted from the interface 30 to the graphics processing unit 40 and the NFC tag 34. The content transmitted to the graphics processing unit 40 may then be further processed, as necessary, before being transmitted for display 54 on the display 12. The remainder of the content may then be stored 56, such as in the processor 38 or the NFC tag 34, and generally relates to the data which is to be transmitted 58 (via the NFC tag 34) to a user if the presence of a mobile device 36 is detected.

For instance, if the user sees an advertisement on the display 12 for a restaurant and wishes to try the restaurant, they may then wave their mobile communication device 36 around the adapter 20a or 20c or tap the device 36 against the adapter 20a or 20c to obtain a coupon or further content relating to the restaurant.

This process is then repeated for new advertising content whenever desired or scheduled.

FIG. 4b provides a flowchart outlining the collection and transmission of impression information. In the current embodiment, the adapter 20 preferably being used is the proximity sensor adapter 20b, however, the NFC adapter 20a or the combined adapter 20c may be used as well. In operation, as the advertising content is being displayed 60 on the display 12, the sensor portion, such as the proximity sensor 44 or the NFC tag 34 or both, retrieve impression information 62 relating to the presence of individuals which are proximate the adapter 20 or individuals who are requesting more further data. The proximity sensor 44 may also assist in determining a length of time that individuals are proximate the adapter. This impression information is then transmitted 64 to the processor 38. In one embodiment, the processor 38 retrieves the impression information from the proximity sensor 44. The impression information may also include the time of day and/or the day of the week along with other identification information.

After receiving the impression information, the processor 38 forwards or transmits 66 this information to a computer or server associated with the organization so that the organization may be able to use this impression information in making business decisions regarding the advertising content.

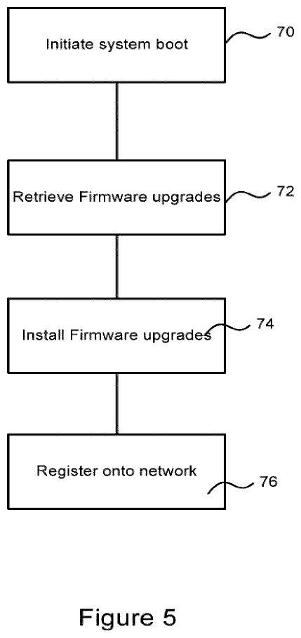

Turning to FIG. 5, a flowchart outlining a method of operation is shown. The current flowchart is directed at a method of start-up for an adapter 20. Firstly, the adapter is turned on in order to activate or initiate a system boot 70. After a successful system boot, the adapter fetches or retrieves 72 firmware upgrades before installing 74 the upgrades onto the adapter 20. In one embodiment, the adapter 20 retrieves the firmware upgrades from a server via the Internet or stored within the cloud network. The firmware upgrades may then be stored within the adapter 20 before the installation process or the firmware upgrade may be executed at its stored location within the Internet.

After installing the firmware upgrades, if necessary, the adapter registers 76 itself on the cloud network. In one embodiment, the adapter polls a list of known servers to establish a connection between the adapter and the cloud network. If at any time, this registration is lost or the adapter is disconnected from the cloud network, the adapter may simply re-register 76.

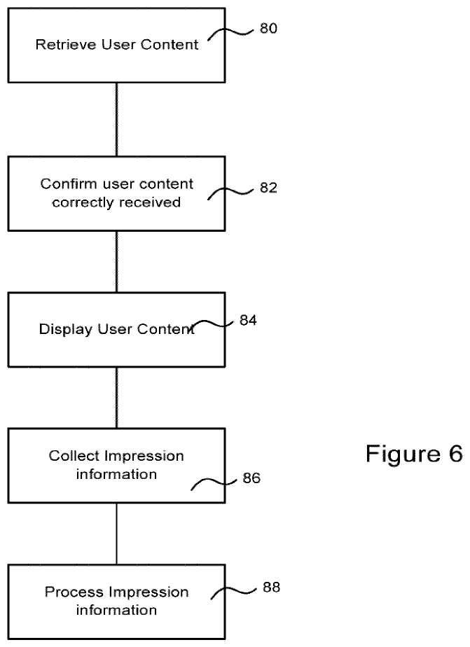

After registering, the adapter may execute a main operation process as schematically shown in FIG. 6 which is a flowchart outlining a method of impression information collection. Once registered, the adapter retrieves 80 the user content, in the form of an advertisement, to be shown on its display such as disclosed above. Data for the NFC tag 34 may also be retrieved at this time, where relevant. Once it is confirmed that the user content has been correctly received 82, the user content is then displayed 86.

In one example, if the user content is advertising, the advertising may include a set of content files and a set of configuration files. In a preferred embodiment, the adapter 20 is capable of supporting different types of content files, such as, but not limited to, static images slideshows, video or audio.

When fetching the user content, the adapter may attempt to select a format and aspect ratio more suitable for use with the display and which can be handled or processed by the graphics processing unit 40. In a further embodiment, the software platform within the processor may implement a caching scheme to avoid repeated downloads of the same content, since different advertising content will usually be shown multiple times on the same display. The caching mechanism identifies content files by their MD5 hash values.

The configuration files describe how and when the user content should be presented on the display. These configuration files may dictate scheduling rules, associated NFC content, interactivity rules (how user content changes in response to user interaction), and/or content configuration (slideshow transitions, video brightness etc.) Control of the adapter 20 may also be done externally via commands which are issued by a controller.

While displaying the advertising content, the adapter also collects 86 and processes 88 data associated or related to the how well the advertisement is being received by customer or patrons. This may be performed by sensing the number of individuals who are in proximity of the adapter or by determining how long individuals are in proximity of the adapter or a combination of how many and how long individuals are proximate the adapter.

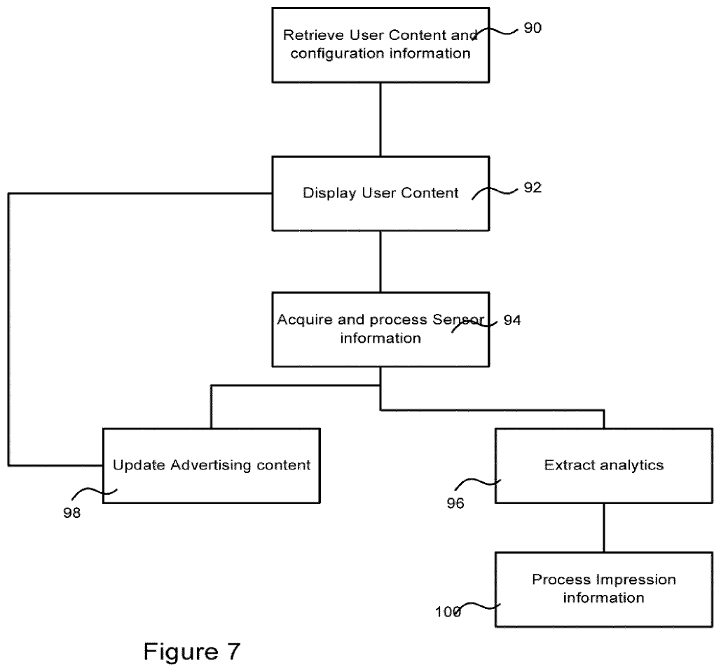

Turning to FIG. 7, a further flowchart outlining a further method of collecting impression information is shown. In operation, the user content, such as advertising content along with configuration information is retrieved 90 from a server or a set of servers. After being verified, the advertising content is then shown on the display 92. As discussed above, use of the adapter 20 results in the collection of information, such as, but not limited, impression information, proximity information, the number of times users retrieve further content via NFC, the interactions between the adapter and mobile communication devices etc. After a period of time, the collected information is acquired 94 by the processor. This information may then be processed to extract analytics 96 from the information or to update the user content being shown on the display 98 or both. After extracting the analytics, the analytics may be uploaded 100 to a server via the Internet interface.

In another embodiment, the adapter 20a or 20c may support bi-directional NFC communication. In this manner, content may be pushed from the adapter to NFC-enabled devices, such as mobile communication devices, as well as read from active NFC-enabled devices. For example, a user may use their mobile communication device to upload results of a short survey to the adapter. In cases where the advertising content is configured to accept this type of user interaction, the received information may be used to drive interactivity and extract analytics.

In another embodiment, the adapter may recognize specific NFC commands for configuration purposes. For instance, commands related to firmware updates, Wi-Fi configuration, de-bugging and device resets may be used.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of correlating mobile communication device users in proximity to a display to advertising content, the method comprising:
receiving impression information from an adapter attached to the display,
where the adapter comprises an interface for communicating with a server, a processor, and a proximity sensor for retrieving mobile communication device proximity information, wherein the processor retrieves the advertising content data via the interface for display by the display and the proximity sensor retrieves mobile communication device proximity information associated with the advertising content being displayed;
where the advertising content data includes advertising content time information;
where the impression information includes mobile communication device proximity information, the mobile communication device proximity information including mobile communication device presence time information indicating at least one time that at least one mobile communication device was in proximity to the adapter;
matching the advertising content time information from the advertising content data with mobile communication device proximity time information; and storing associations of advertising content and mobile communication devices; and
outputting at least one analytics report based on at least one association of at least one advertising content and at least one mobile communication device.

2. The method of claim 1, where the adapter further comprises a near field communication tag and the mobile communication device proximity information comprises near field communication information.

3. The method of claim 2, where the near field communication information includes information on advertising content downloaded to a mobile communication device via a near field communication tag, and the step of outputting at least one analytics report comprises outputting at least one analytics report based on at least one association of at least one advertising content and at least one mobile communication device and at least one download of advertising content via a near field communication tag.

4. The method of claim 1, wherein the impression information further comprises the advertising content data.

5. The method of claim 4, where the adapter further comprises a near field communication tag and the mobile communication device proximity information comprises near field communication information.

6. The method of claim 5, where the near field communication information includes information on advertising content downloaded to a mobile communication device via a near field communication tag, and the step of outputting at least one analytics report comprises outputting at least one analytics report based on at least one association of at least one advertising content and at least one mobile communication device and at least one download of advertising content via the near field communication tag.

7. A method of correlating mobile communication device users in proximity to a display to advertising content, the method comprising:
attaching an adapter to the display,
where the adapter comprises an interface for communicating with a server, a processor, and a proximity sensor for retrieving mobile communication device proximity information, wherein the processor retrieves the advertising content via the interface for display by the display and the proximity sensor retrieves mobile communication device proximity information associated with the advertising content being displayed;
where the advertising content data includes advertising content time information;
where the mobile communication device proximity information includes mobile communication device presence time information indicating at least one time that at least one mobile communication device was in proximity to the adapter;
the microprocessor matching the advertising content time information from the advertising content data with mobile communication device proximity time information and storing associations of advertising content and mobile communication devices; the microprocessor outputting at least one analytics report based on at least one association of at least one advertising content and at least one mobile communication device; and
transmitting the at least one analytics report to an external server.

8. The method of claim 7, where the adapter further comprises a near field communication tag and the mobile communication device proximity information comprises near field communication information.

9. The method of claim 8, where the near field communication information includes information on advertising content downloaded to a mobile communication device via a near field communication tag, and the step of outputting at least one analytics report comprises outputting at least one analytics report based on at least one association of at least one advertising content and at least one mobile communication device and at least one download of advertising content via the near field communication tag.

10. An adapter for correlating mobile communication device users in proximity to a display attached to the adapter to advertising content, the adapter comprising:
an interface for communicating with a server; a processor; and a proximity sensor for retrieving mobile communication device proximity information;
the processor configured to retrieve the advertising content via the interface for display by the display and the proximity sensor configured to retrieve mobile communication device proximity information associated with the advertising content being displayed;
where the advertising content data includes advertising content time information and where the mobile communication device proximity information includes mobile communication device presence time information indicating at least one time that at least one mobile communication device was in proximity to the adapter;
the microprocessor configured to match the advertising content time information from the advertising content data with mobile communication device proximity time information and store associations of advertising content and mobile communication devices; the microprocessor configured to output at least one analytics report based on at least one association of at least one advertising content and at least one mobile communication device; and
the microprocessor configured to transmit the at least one analytics report to an external server.

11. The adapter of claim 10, where the adapter further comprises a near field communication tag and the near field communication tag is configured to retrieve information on use of the near field communication tag and the microprocessor is configured to output at least one analytics report based on at least one association of at least one advertising content and at least one mobile communication device and at least one use of the near field communication tag.

12. The adapter of claim 11, where information on use of the near field communication information includes information on advertising content downloaded to a mobile communication device via the near field communication tag, and the microprocessor is configured to output at least one analytics report based on at least one association of at least one advertising content and at least one mobile communication device and at least one download of advertising content via the near field communication tag.
